(19) United States
(12) Patent Application Publication
(10) Pub. No.: US 2023/0400605 A1
(43) Pub. Date: Dec. 14, 2023

(54) Reusable protective tempered glass for touch and non touch screens of electronic devices

(71) Applicant: Waqas Javed, Lorton, VA (US)

(72) Inventor: Waqas Javed, Lorton, VA (US)

(21) Appl. No.: 18/332,701

(22) Filed: Jun. 9, 2023

Related U.S. Application Data
(60) Provisional application No. 63/350,647, filed on Jun. 9, 2022.

(51) Int. Cl. G02B 1/14; C09J 7/40

(52) U.S. Cl. CPC G02B 1/14; C09J 7/40; H04B 1/3888

(57) ABSTRACT

With present invention, as disclosed in U.S. Provisional Patent Application No. 63/350,647 filed on Jun. 9, 2022, we describe a new tempered glass for touch and non-touch screens. Unlike existing protecting films, our development offers increased flexibility, reusability, and an easier application process. The advantages described above result in the reduction of the tedious work associated with the installation of a screen protector. Thus, allowing the users of the electronic devices the opportunity to install them themselves without the help of third parties. Our newly developed film includes a protective film, a tempered glass screen protector with electroplating AF coating, an adhesive layer, and a release liner. It also includes specially made stickers to clean the surface before application and the adhesive layer of the protector for re-application. The proposed protector can also be cleaned using regular soap, water, paper, or a towel cloth to remove dust and be re-utilized.

This application claims the benefit of U.S. Provisional Patent Application No. 63/350,647 filed on Jun. 9, 2022, entitled “Reusable protective tempered glass for touch and non-touch screens of electronic devices” the disclosure of which is at this moment incorporated by reference in its entirety.

### CROSS-REFERENCE TO RELATED APPLICATIONS

Patents related to protecting films or their derivatives for their use on screens of electronic devices have been granted in the past. However, the protecting film of our design offers several advantages over the existing, such as easier installation, the opportunity of reusability, and also reduction of loss of money associated with the wrong installation. Expanding on the latter, when the existing protective films are not installed correctly on the first attempt, they must be replaced with a new one, resulting in money loss. On the contrary, with our unique technology, the protective film can endure multiple installation attempts without compromising the product's functionality. Additionally, our product offers improved strength and flexibility compared to existing related inventions, as follows:

U.S. Pat. No. 10,009,057B2 Protective films for electronic devices, U.S. Pat. No. 7,389,869B2 Display protective film application kit, U.S. Pat. No. 7,784,610B2, Protective film application kit and method, U.S. Pat. No. 7,957,524B2 Protective covering for an electronic device, U.S. Pat. No. 8,567,596B1 Electronic device protecting film application film and method, US20150277502A1 Mobile device screen protector installation tray and system, U.S. Pat. No. 8,044,942B1 Touch screen protector, U.S. Pat. No. 9,580,626B2 System for securing protecting films to surfaces or substrates, U.S. Pat. No. 746,265S1 Assembly for applying a protective film to an electronic device, US20130295333A1 Tempered glass sheet for a touch panel, and method for manufacturing same, US20120309469A1 Telephone screen protector, U.S. Pat. No. 9,452,591B2 Tempered glass screen protector applied to a portable electronic device, US20130215497A1 Screen protector, US86755353B1 Screen protector applicator, CN203427400U Display screen protector, U.S. Pat. No. 9,061,542B1 Glass touch screen protector, US20130045372A1 Screen protector film.

### FIELD OF THE INVENTION

Our invention relates to protective products or systems for electronic devices with a touch or non-touchscreen, including cell phones, tablets, computers, and monitors. The proposed development is mainly designed for users who desire to reduce expenses by installing the protecting film without the help of third parties and by acquiring a reusable film.

### BACKGROUND OF THE INVENTION

Previous related inventions can offer specific protection to the screen of an electronic device, but none of them provide the reusability or reinstallation properties our product does. The developed adhesive technology in the proposed protecting film is capable of filling scratches and wrapping dust particles on the screen's surface where it will be located.

### SUMMARY OF THE INVENTION

The installation of the protector on the screen of an electronic device is generally affected by environmental factors, such as dust, oil stains, spots, and fingerprints, amongst others. Said factors, when not removed properly, cause the formation of bubbles or partial obstruction of the screen's viewing area, resulting in faulty installation, loss of the product, and waste of time and labor.

Additionally, different devices might carry various types of screens, including a replaced one, which may not possess the same quality standards as an original, directly affecting the performance of a regular existing screen protector by having some or all of the following issues, depending on the quality of the screen:

Poor and inconsistent surface flatness due to the polishing process of the glass cover of the screen.

Inconsistency in the 2.5D radian at the edge of the glass cover, Changes from the 2D structure of the device manufacturer factory glass screen cover to a 2.5D structure.

Formation of micro scratches on the screen glass cover.

According to the problems presented above, we developed this new technology to protect film, which solves the most common problems of the existing related products:

The newly developed adhesive can wrap oil stains like fingerprints and dust particles and does not form bubbles during the installation. Additionally, when the film is to be reused or reapplied, the dirt on the protector's adhesive layer can be removed with the dust removal sticker (included). The protector can also be cleaned with regular soap and water when needed.

The composition of the adhesive, the base material, and the thickness are key factors developed to achieve a protective film that could adapt to the screen glass cover of most electronic devices in a wide range of qualities. These factors allow a better installation experience and solve the problem of non-sticking edges after installation. In addition, the adhesive of our protector can fill some of the scratches on the glass cover of the screens.

### BRIEF DESCRIPTION OF DRAWINGS

FIG. 1.—Structure of the Tempered Glass Protector.

FIG. 2.—Adhesive Structure.

FIG. 3.—Different Models of the Tempered Glass Protector.

### DETAILED DESCRIPTION OF THE INVENTION

The Reusable Protective tempered glass for touch and non-touch screens of electronic devices includes a tempered glass protector and a cleaning kit for the screen and the protector. The composition and specifications of the protector and its parts are the following:

Adhesive structure (FIG. 2): 200 um (+/−10 um) acrylic PSA [6], 50 um PET substrate [7], 50 um (+/−5 um) Silicone PSA [8]

Adhesive optical properties tested with test method ASTM D 1003: Transmittance >90%, Haze <1.6%, Yellow Index <0.5%.

Adhesive performance test specifications (30 min on PET, peel-off speed=300 mm/min): 180° peel adhesion for the acrylic PSA layer[6]>1600 gf by test method KS T Acrylic PSA, 180° peel adhesion for the Silicone PSA layer[8] between 8 and 12 gf by test method KS T Silicone PSA.

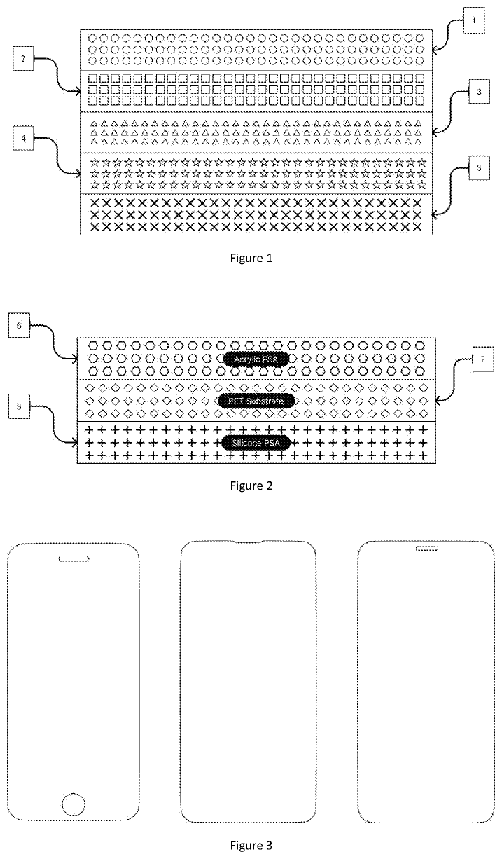

Protector structure (FIG. 1): 0.125 mm protective film[1], 0.300 um electroplating AF coating[2], 0.330 mm tempered glass[3], 0.300 mm adhesive layer[4], 0.250 mm release liner[5].

Protector performance characteristics and tests: high transparency, light transmittance of over 92%, electrostatic absorption, favorable bonding, no formation of bubbles, no glue residues, no dust retention.

Protector Properties: glass thickness: 330+/−10 um, adhesive thickness: 300+/−5 um, adhesion to SUS <20 g/50 mm by test method FINAT-1, adhesion to glass <20 g/50 mm by test method FINAT-1, 2.5D edge process=60 um by quadratic element tester, edge strength=30 Kg by test method ASTMC1279, gluewater deviate test passed by test method SOP-Q-0011, steel ball drop test=1.9 M/64g by test method ASTM D1709, water droplets angle test >115° initially and >105° after 1000 frictions tested by a water drop angle tester and a friction tester.

### EXAMPLES

The developed product is a screen protector of high quality for electronic devices that is easy to install and reusable. This innovative product will protect the screen of electronic devices with reduced costs, time of application, and labor. This protector will be available for various products such as cell phones, smartphones, tablets, laptops, and other electronic devices with a touch or non-touch display and a wide range of qualities. An example of the use of the proposed development is when a final user buys and installs by themselves a tempered glass protector on a cell phone. The task may be difficult or even impossible with the currently existing products. However, with the developed protector, the user could easily do it without external help and waste money since it can be reapplied if the initial attempt is unsuccessful.

1. The reusable tempered glass protector for touch or non-touch screens comprises: A tempered glass layer, an electroplating AF Coating over the tempered glass layer, an adhesive layer over the other side of the tempered glass layer, a release protective liner over the adhesive layer, and a final protective film layer.

2. The adhesive used in the manufacturing process of the reusable tempered glass protector, as stated in claim 1, makes it able to be cleaned and reused several times.

3. The adhesive used in the manufacturing process of the reusable tempered glass protector, as stated in claim 1, makes it able to be installed in a device with certain scratches by filling them to avoid bubble formation between the device and the tempered glass protector.

4. The adhesive used in the manufacturing process of the reusable tempered glass protector, as stated in claim 1, makes it able to be reinstalled for convenience.

5. The adhesive used in the manufacturing process of the reusable tempered glass protector, as stated in claim 1, makes it able to be removed from a device and installed in a different one, thus, reducing costs.

6. The adhesive used in the manufacturing process of the reusable tempered glass protector, as stated in claim 1, makes it able to be installed even with certain particles of dust on the surface. The adhesive absorbs these particles and makes them almost not noticeable, avoiding obstruction of the view area in the display.

7. The adhesive used in the manufacturing process of the reusable tempered glass protector, as stated in claim 1, is made of one layer of PET substrate, one layer of acrylic PSA, and one layer of silicone PSA, allowing it to be firmly fixed to the screen of the device but also to be easily removed or transferred.

8. The electroplating AF coating in the reusable tempered glass protector, as stated in claim 1, avoids fingerprints or any other marks on the surface of the protector. Also, it allows easy displacement of the finger when the protector is applied to a device's touch screen.

9. The adhesive and tempered glass used in the reusable glass protector's manufacturing process of the reusable tempered glass protector, as stated in claim 1, allows for a light transmittance of over 90%, a Haze under 1.6%, and a yellow index under 0.5%.

10. As stated in claim 1, the reusable tempered glass protector includes a cleaning kit that facilitates dry cleaning and, thus, an easy installation or reinstallation when needed.
